(19) United States
(12) Patent Application Publication
(10) Pub. No.: US 2026/0359616 A1
(43) Pub. Date: Nov. 12, 2026

(54) SELF-TIMED FEEDFORWARD SYNTHESIZABLE AND TECHNOLOGY SCALABLE MIXED-SIGNAL NEURONS

(71) Applicant: Innatera Nanosystems B.V., Rijswijk (NL)

(72) Inventors: Aditya DALAKOTI, Rijswijk (NL); Jinbo ZHOU, Rijswijk (NL); Kamlesh Kumar SINGH, Rijswijk (NL); Vasile TOMA, Rijswijk (NL)

(21) Appl. No.: 19/139,913

(22) PCT Filed: Jan. 17, 2024
(86) PCT No.: PCT/EP2024/051056

§ 371 Date: Jun. 17, 2025

Related U.S. Application Data
(60) Provisional application No. 63/439,286, filed on Jan. 17, 2023.

(51) Int. Cl. G06N 3/049

(52) U.S. Cl. CPC G06N 3/049

(57) ABSTRACT

The present invention relates to a spike capture and local trigger generation module for a neuron of a spiking neural network. The module comprises spike input ports, each configured to receive a spike input signal. Furthermore, the module comprises a pulse latch module, configured to capture spikes in the spike input signals by pulse latching. The pulse latch module outputs for each of the spike input ports a latched signal which indicates whether or not a spike was captured. The module further comprises a local trigger generator module, configured to generate a trigger signal used to synchronize and/or control the timing of operations in the neuron, and configured to use the latched signals to generate the trigger signal such that the trigger signal comprises pulses equal in number to the number of spikes captured. Finally, the module may comprise a trigger signal output port that outputs the generated trigger signal.

### TECHNICAL FIELD

The present invention relates to automatic signal recognition techniques, and more particularly, to systems and methods for hardware-resilient deep-learning inference accelerators using spiking neural networks.

### BACKGROUND

Spiking neural networks (SNNs) are signal processing systems whose design is inspired by biological neural networks. Information is encoded in patterns of spike signals distributed across a complex network of neurons and synapses.

The synapses store information and use this to perform basic operations on incoming signals. The neurons generate new spikes based on signals coming in from the synapses. The connections between synapses and neurons determine the shape of the SNN, which together with the information stored in the synapses determines the signal-processing function of the SNN.

There exist a lot of digital implementations in the literature for the typical functions performed in the neurons in the spiking neural networks. See for example P Kampf, P Koch, K Roy, M Sullivan, Z Delalic, and S DasGupta, “Optimization Of A Digital Neuron Design,” in 1990 Eastern Multiconference. Record of Proceedings. The 23rd Annual Simulation Symposium, 1990, pp. 73-80. Another example is D. Lee, G. Lee, D. Kwon, S. Lee, Y. Kim, and J. Kim, “Flexon: A Flexible Digital Neuron for Efficient Spiking Neural Network Simulations,” in 2018 ACM/IEEE 45th Annual International Symposium on Computer Architecture (ISCA), 2018, pp. 275-288. These functions can include operations like addition/subtraction, multiplication, division, and/or complex state machines.

On the other side of the spectrum, there are a lot of analog implementations of neurons in SNN. See for example A Joubert, B Belhadj, O Temam, and R Heliot, “Hardware spiking neurons design: Analog or digital?,” in The 2012International Joint Conference on Neural Networks (IJCNN), 2012, pp. 1-5. Another example is given in J M Zurada, “Analog implementation of neural networks,” IEEE Circuits and Devices Magazine, vol. 8, no. 5, pp. 36-41, 1992, doi: 10.1109/101.158511. One can also look at A. Rubino, M. Payvand, and G. Indiveri, “Ultra-Low Power Silicon Neuron Circuit for Extreme-Edge Neuromorphic Intelligence,” in 2019 26th IEEE International Conference on Electronics, Circuits and Systems (ICECS), 2019, pp. 458-461. They have the advantage of encoding more value states in a smaller and power efficient manner sometimes at the cost of the signal-to-noise ratio (SNR). There exists phase encoded neurons as well which take the advantage of doing computation using phase as the continuous time variable [6]. See for example A. Madhavan, T. Sherwood, and D. Strukov, “Race logic,” ACM SIGARCH Computer Architecture News, vol. 42, pp. 517-528, Dec. 2014, doi: 10.1145/2678373.2665747. They also suffer from the same trade-off as analog neurons, i.e., phase encoded neurons might suffer from a worse SNR.

The benefit of digital neurons stems from the fact that whatever function is implemented by them has a defined state stored at every clock cycle. The states are unambiguous values which are not corrupted over time. The problem of digital neurons stems from the fact that every time an operation is performed, a notion of clear defined time is created using a clocking element like a phase locked loop based voltage control oscillator. The distribution of this clock network ends up consuming a major fraction of the power. See for example S. Ali Butt, S. Schmermbeck, J. Rosenthal, A. Pratsch, and E. Schmidt,System Level Clock Tree Synthesis for Power Optimization. [IEEE Computer Society], 2007, p. 1682.

An extension of digital neurons which alleviates the problem of clock distribution is based on the arbitration of incoming signals using multiple phases of an oscillator. See for example J. Stuijt, M. Sifalakis, A. Yousefzadeh, and F. Corradi, “μBrain: An Event-Driven and Fully Synthesizable Architecture for Spiking Neural Networks,” Frontiers in Neuroscience, vol. 15, Dec. 2021, doi: 10.3389/fnins.2021.664208. This extension solves the problem of avoiding phase locking and global clocking distribution. The system is not scalable since scaling the system would require faster multi-phase oscillators with more clocking distribution. It has better power characteristics but suffers from the same trade-offs as a conventional digital neuron system.

Another style of digital neuron implementation tackles this tradeoff using the mechanism of handshakes and approaches the problem from an asynchronous perspective. See for example A. Yousefzadeh et al., “Asynchronous Spiking Neurons, the Natural Key to Exploit Temporal Sparsity,” IEEE Journal on Emerging and Selected Topics in Circuits and Systems, vol. PP, Dec. 2019, doi: 10.1109/JETCAS.2019.2951121. The problem with this approach is that the scalability results in latency, and that the power from the handshakes dominates the system.

### SUMMARY OF INVENTION

In order to solve the aforementioned problems, the subject-matter of the present claims is proposed.

In a first aspect of the present invention, a spike capture and local trigger generation module for a neuron of a spiking neural network is disclosed. The module may comprise multiple spike input ports. Each of the multiple spike input ports may be configured to receive a spike input signal from the spiking neural network. Furthermore, a pulse latch module may be comprised within the module. The pulse latch module may be configured to capture spikes in the spike input signals received by the spike input ports by pulse latching. Pulse latching can be described as a digital circuit mechanism that captures and retains a state in response to a triggering pulse, storing the state until reset by a subsequent pulse. The state can be forwarded to other parts of the module. The pulse latch module may output for each of the multiple spike input ports a latched signal which indicates whether or not a spike was captured. Furthermore, a local trigger generator module may be comprised within the module. The local trigger generator module may be configured to generate a trigger signal used by the neuron to synchronize and/or control the timing of operations in the neuron. The local trigger generator module may be configured to use the multiple latched signals to generate the trigger signal such that the trigger signal comprises one or more pulses equal in number to the number of spikes captured by the pulse latch module. The trigger signal thus obtained may be used to trigger operations performed by other parts of the neuron, hence providing a local event-based triggering mechanism. The invention thus does not need a global clock signal to operate those parts of the neuron. In order to use the trigger signal, the module may comprise a trigger signal output port, configured to output the generated trigger signal.

In an embodiment of the first aspect, the trigger signal may be generated such that the operations in the neuron can be triggered by the trigger signal and not by a global clock signal of the spiking neural network.

In an embodiment of the first aspect, the trigger signal may be a delay-based asynchronous counter.

In an embodiment of the first aspect, the one or more pulses comprised in the trigger signal may have a certain spacing between the pulses, which may be determined by the minimum time taken by the operations in the neuron to perform. Preferably, the operation may be the accumulation of one or more weights.

In an embodiment of the first aspect, the module may further comprise multiple spike output ports, each configured to output a spike output signal. Each of the multiple spike output ports may correspond to one of the multiple spike input ports. A particular spike output port may be configured to output a pulse if a corresponding spike input port received a spike.

In an embodiment of the first aspect, the pulses outputted by the spike output ports may be spaced in time substantially the same as the pulses comprised in the clock signal.

In an embodiment of the first aspect, pulse latch module may comprise multiple latch elements. Each latch elements may be configured to capture one or more spikes in the spike input signal received by a particular spike input port by pulse latching.

In an embodiment of the first aspect, the latch element may be a CMOS D Flip-Flop. The CMOS D Flip Flop may be triggered by a spike input signal. The latched signal outputted by the CMOS D Flip Flop may be a bit value indicating whether a spike was latched or not.

In an embodiment of the first aspect, the local trigger generator module may comprise a pulse generator which generates a pulse. The local trigger generator module may comprise delay logic for each spike input port. The generated pulse may be sent through each of the delay logic subsequently.

In an embodiment of the first aspect, each of the delay logic may comprise a delay element that delays the pulse signal. The generated pulse may be sent through the delay element of a particular delay logic if the corresponding latched signal indicates that a spike was captured by the corresponding spike input port. The generated pulse may not be sent through the delay element of the particular delay logic if the corresponding latched signal indicates that a spike was not captured by the corresponding spike input port.

In an embodiment of the first aspect, the generated pulse may be outputted by a particular delay logic to generate the trigger signal if the corresponding latched signal indicates that a spike was captured by the corresponding spike input port. The generated pulse may not be outputted by the particular delay logic to generate the trigger signal if the corresponding latched signal indicates that a spike was not captured by the corresponding spike input port.

In an embodiment of the first aspect, the local trigger generator module may be configured to generate multiple trigger signals used by the neuron to synchronize and/or control the timing of operations in respective parts of the neuron. The local trigger generator module may be configured to use the multiple latched signals to generate the multiple trigger signals such that each trigger signal comprises one or more pulses equal in number to the number of spikes captured by the pulse latch module for a particular set of spike input ports. The module may further comprise multiple trigger signal output ports, configured to output the generated trigger signals.

In an embodiment of the first aspect, the module may further comprise a multi-level trigger generator module having a multi-level trigger output port which is configured to generate a multi-level trigger signal. The multi-level trigger signal may indicate the total time it would take the neuron to perform the operations triggered by trigger signal. Preferably if there are multiple trigger signals which are generated and outputted, the multi-level trigger signal may correspond to the maximal time it would take the neuron to perform all the sets of operations triggered by the different trigger signals.

In a second aspect of the present invention, a weight encoding and accumulation module for the accumulation of spike input signals in a neuron of a spiking neural network is disclosed. The module may comprise multiple spike input ports. Each of the multiple spike input ports may be configured to receive a spike input signal. Furthermore, the module may comprise a trigger signal input port, which may be configured to receive a trigger signal. The pulses comprised in the trigger signal may indicate the number of spikes received by the multiple spike input ports. Furthermore, the module may comprise a spike-to-weight encoder module. The spike-to-weight encoder module may be configured to receive the spike input signals and output a corresponding weight associated with a particular spike input signal. This may be done by encoding the received spike input signals as weight. Furthermore, an accumulator module may be comprised in the module. The accumulator module may be configured to receive the weight from the memory module and the trigger signal and accumulate the weights of received spikes. The timing of one or more of the operations involved in the accumulation may be governed by the trigger signal.

In an embodiment of the second aspect, each of the spike input signals may be an analog signal. The weights may be digital values.

In an embodiment of the second aspect, the accumulator module may comprise an accumulation element and a loop circuit which takes as input the output of the accumulation element and which outputs a value back to the accumulation element each time the loop circuit receives a pulse from the trigger signal. When the spike-to-weight encoder module outputs a first weight to the accumulation element, the first weight may be summed by the accumulation element with a second weight outputted by the loop circuit.

In an embodiment of the second aspect, the loop circuit comprises CMOS D Flip Flop, which may be triggered by the trigger signal.

In an embodiment of the second aspect, the spike-to-weight encoder module may comprise a local memory, preferably a SRAM or a non-volatile memory. The spike-to-weight encoder may encode a pulse received at a particular spike input port as a memory address which is used to request a weight stored in that particular memory address. The weight may be associated with the particular spike input port.

In an embodiment of the second aspect, the spike-to-weight encoder module may comprise a distributed memory comprising distributed weight storage elements. The weights associated with the spike input ports may each be stored in one of the distributed weight storage elements. If a spike is present in a spike input signal the corresponding weight may be outputted to the accumulator module by the distributed weight storage element where the weight is stored.

In an embodiment of the second aspect, the spike-to-weight encoder module may be configured to change the order at which weights are output based on priority rules.

In a third aspect of the present invention, a spiking neuron of a spiking neural network is disclosed. The neuron may comprise the spike capture and local trigger generation module according to the first aspect. The neuron may additionally or alternatively comprise the weight encoding and accumulation module according to the second aspect. The trigger signal output port of the spike capture and local trigger generation module may output the trigger signal to the trigger signal input port of the weight encoding and accumulation module. This may be done in such a way that the timing of one or more of the operations involved in the accumulation is governed by the trigger signal.

In an embodiment of the third aspect, the neuron further may comprise a comparator module which compares the total accumulated weight with a predetermined threshold value. The total accumulated weight may be the sum of all weights of spike input ports for which a spike of the corresponding spike input signal was captured. The spiking neuron may be configured to output a spike to the spiking neural network when the total accumulated weight exceeds the predetermined threshold value.

In an embodiment of the third aspect, the spiking neuron may comprise multiple weight encoding and accumulation modules according to the second aspect. The spike capture and local trigger generation module may be according to the first aspect. Each of the multiple trigger signal output ports may output a respective trigger signal to the trigger signal input port of a corresponding weight encoding and accumulation module, such that the timing of one or more of the operations involved in the accumulation performed in the corresponding weight encoding and accumulation module may be governed by the respective trigger signal.

In an embodiment of the third aspect, the neuron further may comprise a digital weight accumulator module, which accumulates the output by at least a part of the multiple weight encoding and accumulation modules and outputs the accumulated value.

In an embodiment of the third aspect, the spiking neuron may comprise multiple digital weight accumulator modules. At least one digital weight accumulator module may accumulate the output accumulated value of other digital weight accumulator modules.

In an embodiment of the third aspect, delay-based pipelining and/or handshake-based pipelining may be used to synchronize the accumulation operations between the multiple weight encoding and accumulation modules and/or the one or more digital weight accumulator modules.

In an embodiment of the third aspect, the spike capture and local trigger generation module may be according to first aspect. The multi-level trigger signal may be used to synchronize the accumulation operations between the multiple weight encoding and accumulation modules and/or the one or more digital weight accumulator modules.

In a fourth aspect, a method for spike capture and local trigger generation in a neuron of a spiking neural network, is disclosed. The method may comprise: receiving multiple spike input signals from the spiking neural network; capturing spikes in the spike input signals by pulse latching; generating a latched signal for each of the spike input signals, wherein the latched signal may indicate whether or not a spike was captured; generating a trigger signal using the multiple latched signals such that the trigger signal may comprise one or more pulses equal in number to the number of spikes captured, wherein the trigger signal may be used by the neuron to synchronize and/or control the timing of operations in the neuron; and outputting the generated trigger signal.

In an embodiment of the fourth aspect, the method may further comprise outputting a spike output signal. The trigger signal may be generated such that the operations in the neuron can be triggered by the trigger signal and not by a global clock signal of the spiking neural network.

In a fifth aspect, a method for weight encoding and accumulation in a neuron of a spiking neural network is disclosed. The method may comprise: receiving multiple spike input signals; receiving a trigger signal comprising one or more pulses, wherein the one or more pulses indicate the number of spikes received in the multiple spike input signals; obtaining or generating a weight associated with one of the multiple spike input signals; accumulating the weights of the spike input signals which comprised a spike, wherein the timing of one or more of the operations involved in the accumulation may be governed by the trigger signal; and outputting the accumulated weight.

In an embodiment of the fifth aspect, the weight may be obtained or generated by encoding a pulse received in the one of the multiple spike input signals as a memory address which may be used to request a weight stored in a local memory at that particular memory address.

In an embodiment of the fifth aspect, if a spike is present in a spike input signal the corresponding weight may be obtained from a distributed memory comprising multiple weight storage elements. The weights associated with the spike input signals may each be stored in one of the distributed weight storage elements. If a spike is present in a spike input signal the corresponding weight may be outputted by the distributed weight storage element where the weight is stored and used in the accumulation of the weights.

In as sixth aspect, a method for spike capture and accumulation in a neuron of a spiking neural network is disclosed. The method may comprise: receiving multiple spike input signals from the spiking neural network; capturing spikes in the spike input signals by pulse latching; outputting a latched signal for each of the spike input signals, wherein the latched signal may indicate whether or not a spike was captured; generating a trigger signal using the multiple latched signals such that the trigger signal may comprise one or more pulses equal in number to the number of spikes captured, wherein the trigger signal may be used by the neuron to synchronize and/or control the timing of operations in the neuron; obtaining or generating a weight associated with one or more of the multiple spike input signals; accumulating the weights of the spike input signals which comprised a spike, wherein the timing of one or more of the operations involved in the accumulation may be governed by the trigger signal; and outputting the accumulated weight.

In an embodiment of the sixth aspect, the method may further comprise comparing the total accumulated weight with a predetermined threshold value. The total accumulated weight may be the sum of all weights of spike input signals for which a spike was captured. Furthermore, the method may further comprise outputting a spike to the spiking neural network when the total accumulated weight exceeds the predetermined threshold value.

In an embodiment of the sixth aspect, the steps of obtaining or generating a weight and accumulating the weights may be parallelized by dividing the multiple spike input signals into one or more subsets of the multiple spike input signals. Furthermore, the steps of obtaining or generating a weight and accumulating the weights for these subsets may be concurrently performed such that one obtains an accumulated subset weight for each subset.

In an embodiment of the sixth aspect, the accumulated subset weights may be accumulated digitally, preferably in a parallelized manner.

In an embodiment of the sixth aspect, the delay-based pipelining and/or handshake-based pipelining is used to synchronize the accumulation operations between different subsets and/or the one or more digital accumulations.

### BRIEF DESCRIPTION OF THE DRAWINGS

Embodiments will now be described, by way of example only, with reference to the accompanying drawings in which corresponding reference symbols indicate corresponding parts, and in which:

FIG. 1 shows a schematic depiction of reproducible design blocks connected in an M×N structure;

FIG. 2 shows a schematic depiction of a design methodology according to the present invention;

FIG. 3 shows a schematic depiction of the high-level architecture of a neuron with m spike inputs;

FIG. 4 shows a schematic depiction of the capture of m spike inputs and the associated timing generation;

FIG. 5 shows a schematic depiction of the summation of spike weights from a local memory in a unit cell;

FIG. 6 shows a schematic depiction of the summation of spike weights from a distributed memory in a unit cell;

FIG. 7 shows a schematic depiction of a multi-level self-timed neuron design with reproducible unit cells;

FIG. 8 shows a schematic depiction of a delay-based pipelining; and

FIG. 9 shows a schematic depiction of a handshake-control-logic-based pipelining.

### DESCRIPTION OF EMBODIMENTS

Hereinafter, certain embodiments will be described in further detail. It should be appreciated, however, that these embodiments should not be construed as limiting the scope of protection for the present disclosure.

Self-timed circuits have been explored for various systems and high-performance designs in the literature. See for example S. Fairbanks, “High precision timing using self-timed circuits,” 2009. The implementations can be done using various circuit design techniques like self-resetting logic (see Bloker et. al, “U.S. Pat. No. 5,864,251”), pulse-self timed logic (see M. Miller, C. Segal, D. Mc Carthy, A. Dalakoti, P. Mukim, and F. Brewer, “Impolite High Speed Interfaces with Asynchronous Pulse Logic,” Dec. 2018, pp. 99-104.) et cetera. This style of logic design does not have a clock associated with them. The idea is to combine multiple repeatable patterns of logic in a systematic manner such that each logic block can be completed within a given amount of delay.

In-order to achieve these designs a design methodology has to be established to make larger designs.

Source coupled logic has been shown to be an efficient way to reduce power in digital designs and to operate the designs near the transistor device threshold and at a very low supply voltage. See for example S. Roy and K. Nipun, “Understanding sub-threshold source coupled logic for ultra-low power application”. Integration of source coupled logic in the neuron logic as well as delay design can further lead to area and power optimizations in the design. Self-timed logic has also been shown to optimize the timing performance of CMOS designs. See for example A. Dalakoti, M. Miller, and F. Brewer, “Pulse Ring Oscillator Tuning via Pulse Dynamics,” in 2017IEEE International Conference on Computer Design (ICCD), 2017, pp. 469-472. The inventors of the present invention have realised that this can help in optimizations of the design to create neurons in different timescales. Delay based race computations can also be made repeatable and can help create power efficient logic. See for example A. Madhavan, T. Sherwood, and D. Strukov, “Race logic,” ACMSIGARCH Computer Architecture News, vol. 42, pp. 517-528, Dec. 2014, doi: 10.1145/2678373.2665747.

The inventors of the present invention have realised that the techniques like source coupled design, self-timed logic, delay-based race logic can all be incorporated in the design methodology to create complex neuron structures. The benefit of the design methodology stems from the fact that one can synthesize these structures based on a use case requirement under the presumption of repeatable blocks which are pre-verified and integrated into the design methodology.

All the conventional digital techniques like time multiplexing, memory optimization et cetera can be applied for the designs and can further optimize the designs for area, power or timing trade-offs. The designs can also be augmented with complex connectivities to create complex SNN structures based on each use case needs.

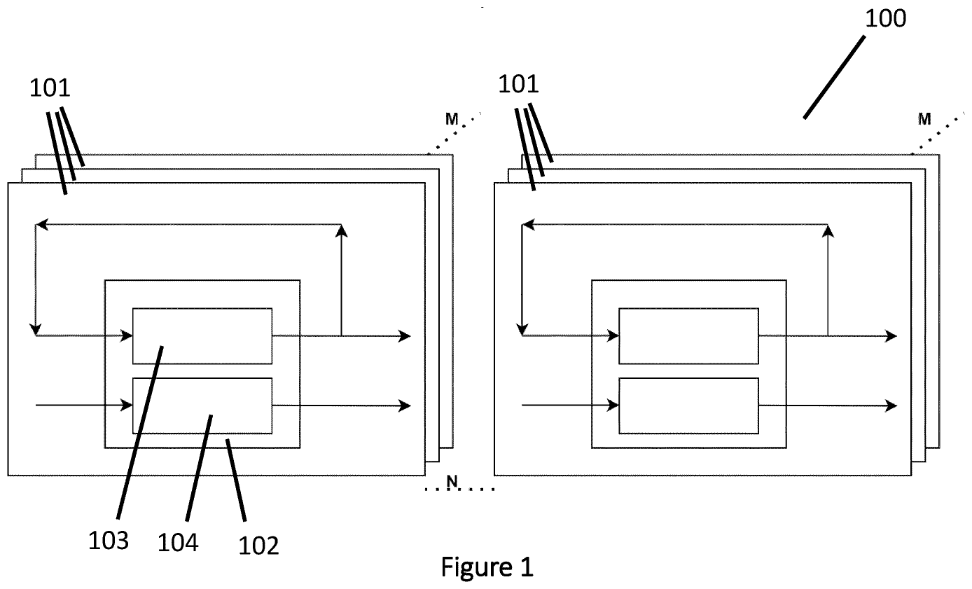

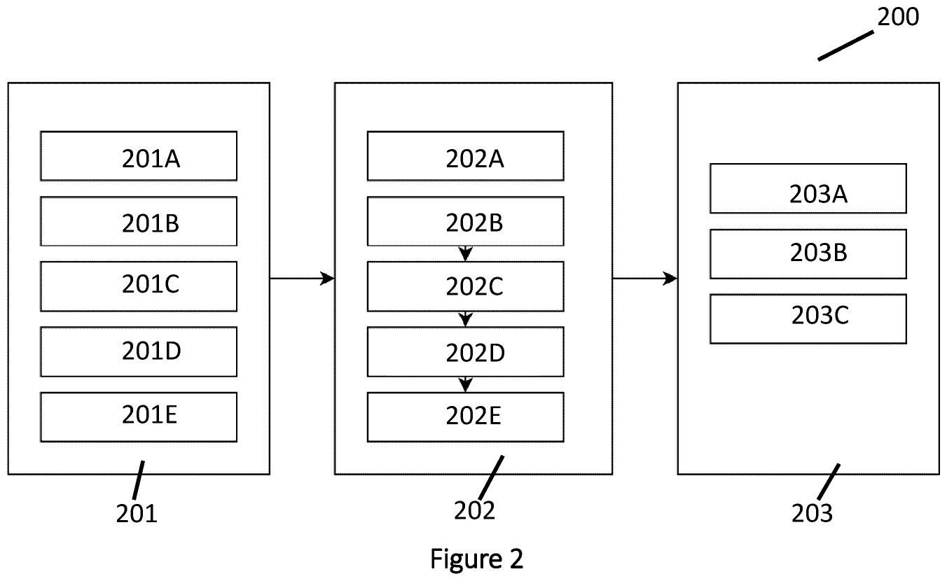

FIG. 1 shows a schematic depiction of reproducible design blocks 101 connected in an M×N structure 100 and FIG. 2 shows a schematic depiction of a design methodology 200 according to the present invention. In particular, FIG. 1 shows the design blocks 101 which can be taken through the design methodology 200 as shown in FIG. 2 to create final connectivities of neurons in an automated fashion.

The reproducible design blocks 101 connected in the M×N structure 100 shown in FIG. 1 refer to a modular architecture where M represents the number of rows and N represents the number of columns of interconnected design blocks 101, and the total M×N structure 100 forms (at least a part of) the SNN. The design blocks 101 can comprise a single neuron, multiple connected neurons and/or more complex circuits. This M×N structure 100 may facilitate parallel processing and can by using the design blocks adhere to modular design principles. The connections between the design blocks 101 may represent synaptic connections in the network. The design blocks may be connected using for example wire connections, crossbar busses with logic like for example NAND trees, Tristate buses and/or routers. Note that the design blocks 101 used in the M×N structure 100 may be similar or different to each other, and may also vary per row and/or column.

The M×N structure 100 promotes a modular design, allowing for easy replication and scalability. Each block 101 can be a self-contained module with specific functionalities, and the entire network can be constructed by replicating and connecting these modules. For example, the different design blocks 101 can be specialized for certain specific tasks or functions. The overall SNN can then be adapted for various applications by adjusting the connectivity and properties of the individual design blocks. The same design blocks 101 can be replicated across different parts of the network, promoting consistency and simplifying the design process. This is beneficial for both hardware and software implementations of SNNs. The grid structure may encourage parallel processing within the network, since design blocks (e.g., neurons) 101 within the same row or column can operate concurrently, enhancing the overall computational efficiency of the network.

Depending on the specific requirements of the task or application, the connectivity patterns between the design blocks 101 within the M×N structure 100 can vary. Common connectivity patterns include nearest-neighbour connections, all-to-all connections, or more complex connectivity schemes. The modular and reproducible nature of the design allows for easy scalability. As the SNN requirements grow, additional rows or columns of design blocks can be added to increase the SNN's capacity without fundamentally changing the architecture.

A design block can comprise a unit cell 102 with a delay circuit 103 and/or a logic circuit 104. These circuits 103, 104 will be discussed further below, and each can have input ports, output ports, and/or feedback loops. The unit cell 102 may for example form a neuron.

Next, the design methodology 200 as shown in FIG. 2 will be discussed. In general, a design methodology 200 according to the present invention uses inputs 201, performs the design steps 202 on these inputs 201 and so obtains the outputs 203 of the design methodology 200. The outputs 203 can for example disclose a configured network architecture, in particular for example an M×N structure as shown in FIG. 1.

The inputs 201 to the design methodology can for example be primitives 201A, logic block RTLs 201B, delay blocks 201C, connectivity requirements 201D and/or timing constraints 201E.

The primitives 201A are design blocks which can be used to design the complex logic circuits for the Register-Transfer Level (RTL) block. RTL is a level of abstraction in digital circuit design that represents a circuit in terms of the flow of data between registers, and the logical operations performed between these registers. An RTL block may represent a portion of the neural network's hardware design described at the register-transfer level. The RTL block may capture the data flow and the operations performed on that data within the hardware. Depending on the style of logic used based on the power performance area requirements, different kinds of primitive designs are possible.

Some exemplary primitive designs 201A that can be used in the design methodology 200 as inputs 201 are: (a) SR CMOS (see for example Bloker et. al, “U.S. Pat. No. 5,864,251”); (b) Pulse Logic (see for example D. Mc Carthy, M. Miller, and F. Brewer, “Automated Timing Constraint Generation for PulseGate Circuits,” in IEEE International Conference on Program Comprehension, 2022, vol. 2022-March, pp. 36-47); (c) Standard CMOS (see for example I. Sourikopoulos et al., “A 4-fJ/spike artificial neuron in 65 nm CMOS technology,” Frontiers in Neuroscience, vol. 11, no. MAR, Mar. 2017, doi: 10.3389/fnins.2017.00123); and/or (d) Source Coupled CMOS Logic (see for example S. Roy and K. Nipun, “Understanding sub-threshold source coupled logic for ultra-low power application”).

Another input 201 can be Logic Block RTL 201B. A neuron block can consist of various mathematical operations. These operations can be captured as a standard RTL description and can be passed to the synthesis flow. In RTL design, registers store data between different stages of computation. In the case of an SNN, these registers might represent the state of neurons, synaptic weights, or other relevant information at different time steps. The RTL description may detail how data is transferred between registers and how various computational operations (e.g., spike generation, synaptic updates) are performed. RTL descriptions may also include timing information, specifying when various operations take place. In SNNs, this can be important for capturing the temporal dynamics of spikes and synapses. The RTL blocks can specify operations specific to the spiking neurons within the SNN, such as spike generation, spike propagation, synaptic weight updates, and any other computations relevant to the spiking behaviour of neurons. Depending on the design, RTL descriptions might also capture parallelism within the SNN, particularly if the hardware implementation involves parallel processing of multiple neurons or synapses.

Another input 201 can be delay block 201C. The delay blocks 201C can be implemented in various forms. The delays can be derived from standard CMOS gates or through specialized analog design to create variable delay. Delay blocks are be used to model the transmission delays associated with synaptic connections between neurons. These delays can play a role in capturing the temporal dynamics of spiking events. Delay blocks 201C can be implemented in various ways, and the choice of implementation depends on the specific requirements of the neural network and the hardware platform. Examples of digital delay blocks include shift registers and digital counters. Each stage of a shift register represents a unit of time, and the signal is shifted through the register to introduce a delay. A digital counter can be employed to count the number of time steps before allowing a signal to pass through. This allows for programmable delays based on the count value. Examples of analog delay blocks include RC circuits and transmission lines. Analog delay blocks may be used to introduce variable delays. An RC circuit, comprising a resistor (R) and a capacitor (C), can be used to create a variable delay by adjusting the values of the resistor and capacitor. The charging and discharging of the capacitor introduce a time constant that determines the delay. Analog delay lines, such as transmission lines, can also be used to introduce delays. The signal travels along the transmission line, and the length of the line determines the delay.

Another input can be connectivity requirements 201D. In a real use case the connectivity between different logic blocks can be varied. This needs to be captured in a separate file, for example a regular expression based connectivity description file, for correct implementation of designs.

Another input can be timing constraints 201E. For the process of making the designs synthesizable, all designs need to be constrained. For example, all logic block paths need to be constrained. The timing constraints 201E can be implemented by bounding the time taken by a logic to perform a certain operation. Examples of timing constraints 201E can be for example: (a) minimum and maximum delay in a path; (b) minimum and maximum capacitance in a path, for example the charging and discharging of the capacitor introduces a time constant that determines the delay; and/or (c) floor planning of the structures to meet the constraints. With respect to the latter point (c) different design choices like the size of the delay, complexity and logic, among others, result in blocks of different size. It is possible that not all the blocks are compatible to be put next to one another to get the maximum utilization of area in the design. An intelligent floor planning is needed in order to find combinations of blocks which can be placed next to one another to get the best area utilization, which can be achieved by the method described.

The different method steps 202 of the design methodology 200 are then performed, based on the input 201.

As a first step, the primitives used in the complex neuron logic need to be characterized for delays. This is done during primitive characterization 202A, preferably in an automated fashion, to create the necessary timing files needed by the synthesis and place and route tool. Scaled voltage libraries need to be characterized for near-threshold computation. Scaled voltage libraries in general are sets of libraries in (digital) integrated circuit design that include components with different threshold voltages (Vt) or supply voltages (Vdd). These libraries are designed to support the creation of circuits that operate at multiple voltage scales. Near-threshold computation is the operation of digital circuits at or near their threshold voltage levels. The threshold voltage is the voltage at which a transistor switches from the off state to the on state. Operating near the threshold voltage is often associated with low-power design strategies in digital integrated circuits. Namely, lowering the supply voltage and operating near the threshold voltage can result in significant power savings compared to traditional higher-voltage operation. As a result, near-threshold computation is particularly relevant in mixed-signal and analog/mixed-signal designs where power efficiency is crucial.

Next, as a second step, the logic for the digital neuron needs to be characterized during logic characterization 202B. The goal is to create an optimized neuron logic block and then use it in a time and space multiplexed manner. In order for the logic block to be used multiple times, macro-IP of the logic blocks are made and then implemented depending on the use case connectivities. IP blocks, often referred to as IP cores or just IPs, are pre-designed, pre-verified, and reusable functional units that can be integrated into larger systems or designs. These IP blocks encapsulate specific functionalities or logic, and they are designed to be easily integrated into various projects to save time and effort. The design procedure is done for block level and top level automation.

As a third step, since there are different kinds of delay design methodologies, each one needs to be characterized during delay characterization 202C. The correct delay is picked based on the logic style and the logic delay. Different delays have different trade-offs associated with them. Some examples are (a) CMOS delay, which are standard delay elements out of a process development kit; or (b) Current Starved Delay, which are area optimized delays controlled with widely tunable digital-to-analog converters. CMOS delay refers to the time it takes for a signal to propagate through a Complementary Metal-Oxide-Semiconductor (CMOS) logic gate, from the input of a CMOS gate to its output. The sizes and characteristics of the n-type transistors (NMOS) and p-type transistors (PMOS) influence the delay. For instance, larger transistors generally have higher drive strength but may also have higher capacitance. The capacitance at the output of the gate, also called load capacitance, which includes the parasitic capacitance of the connected wires and the input capacitance of subsequent gates, may also affect the delay. Current starved delay is a design technique where the delay is primarily controlled by regulating the current flowing through the circuit, and intentionally limiting this current to achieve a desired delay. It can applied for example to ring oscillators and delay-locked loops, present within the network.

As a fourth step, Time and Space Multiplexing 202D can be performed. Namely, logic and connectivity needs to be translated into a hardware implementation with time and space multiplexing. Time multiplexing causes latency and power usage to increase. Space distribution causes the area upon which the network is implemented to increase. Correct design point needs to be chosen (design technology specific) and an automated compiler can generate a block placed within the network, which is routed. The quantification may be based on the power, performance and area (PPA) number we are trying to hit. In general, one tries to find an optimal solution using optimization algorithms like for example convex optimization or simulated annealing.

As a fifth step, the power, performance and area (PPA) is optimized during PPA optimization 202E. These three parameters can for example be optimized: (a) with area dependent on multiplexing; (b) with technology node usage; (c) with mixed signal design control like current starved delay elements; (d) with design methodologies like source coupled logic or self-resetting logic; (e) with pipelining; and/or (f) with signalling between multiplexed designs in space and time correctly chosen.

After having performed these method steps, one obtains the outputs 203 of the design methodology 200, which may include: (a) a final layout 203A, which is the final GDS with the complete digital neuron structures connected in the required network structure; (b) a gate level netlist 203B, which is a gate level netlist with all the primitives characterized in the flow; and/or (c) PPA reports 203C, which are reports of the expected performance, power and area for the use case driven design created.

The final layout 203A can be the physical representation of the SNN design on a semiconductor substrate. It includes the placement of transistors, interconnections, metal layers, and other physical components, forming the synapses and neurons. It provides a map of where each component of the SNN will be located on the chip. “GDS” stands for “Graphic Data System” or “Graphic Design System,” and it refers to a standard file format used to describe the geometric layout of the various components and layers of an IC. The GDS file may be used by semiconductor foundries to manufacture the designed IC.

The gate-level netlist 203B is a textual representation of the SNN design at the gate level. It describes the logical connectivity and functionality of the design in terms of basic logic gates (AND, OR, NOT, et cetera). Each line in the netlist typically represents a gate or flip-flop, and the connections between these elements are explicitly specified. The netlist serves as an intermediate representation that can be used for simulation, verification, and synthesis.

PPA reports 203C provide detailed information on how the SNN design performs in terms of power consumption, speed (performance), and the physical area it occupies on the chip. Power metrics may include dynamic power (associated with switching activity), static power (leakage), and total power consumption. Performance metrics may involve delay characteristics and clock frequencies. Area metrics provide insights into the size of the design.

Next several design examples that can be used with or which are obtained through the design methodology 200 described above are discussed.

One of the fundamental logic operations performed by a neuron is accumulation. Accumulation refers to the process by which a neuron integrates incoming input spikes over time, ultimately determining whether the neuron will generate an output spike. Accumulation captures the temporal dynamics of information processing in the network. Accumulation is performed based on weights associated with particular input spikes received from the network interconnect or from an encoder or sensor via an interconnect.

One common neuron design is a leaky integrate-and-fire (LIF) neuron. The LIF neuron has a membrane potential that evolves over time based on incoming synaptic inputs and a leakage term. Accumulation occurs in the membrane potential of the neuron. The membrane potential represents the electrical potential across the neuron's membrane and is influenced by the synaptic inputs it receives. Each incoming spike from e.g., connected neurons, contributes to the accumulation of the membrane potential. Synaptic weights determine the strength of these contributions. Excitatory synapses increase the membrane potential, while inhibitory synapses decrease it. Leakage may cause the membrane potential to slowly decay over time. This causes the neuron's membrane potential to return to its resting state in the absence of input. When the accumulated membrane potential reaches a certain threshold, the neuron fires or generates an output spike. This threshold is a critical parameter that influences the neuron's responsiveness and sensitivity. After firing, the membrane potential may be reset to a resting or reset value, and the neuron may go through a refractory period during which it cannot fire again immediately.

Accumulation done within the neuron can take different forms depending on interpretation of weights within the neuron logic. Each bit of the weight can have different logic functionality encoded in them. Some examples of logic operation in the neuron accumulation are (a) addition, (b) subtraction, and/or (c) shift left and shift right.

The addition and subtraction logic operations model the accumulation of excitatory and inhibitory spikes respectively. Shifting left involves updating the accumulator or shift register by discarding the least significant bits or the oldest values in the register. Shifting left models the natural decay or leakage of accumulated information over time. For leaky integrate-and-fire (LIF) neurons, it simulates the gradual decrease in membrane potential when no new input spikes are received. Shifting right involves updating the accumulator or shift register by discarding the most significant bits or the most recent values in the register. The shift right operation can be used in specific scenarios to introduce a temporal delay in the accumulation process. It effectively delays the contribution of the most recent input values to the accumulation, allowing the neuron to respond to past input patterns.

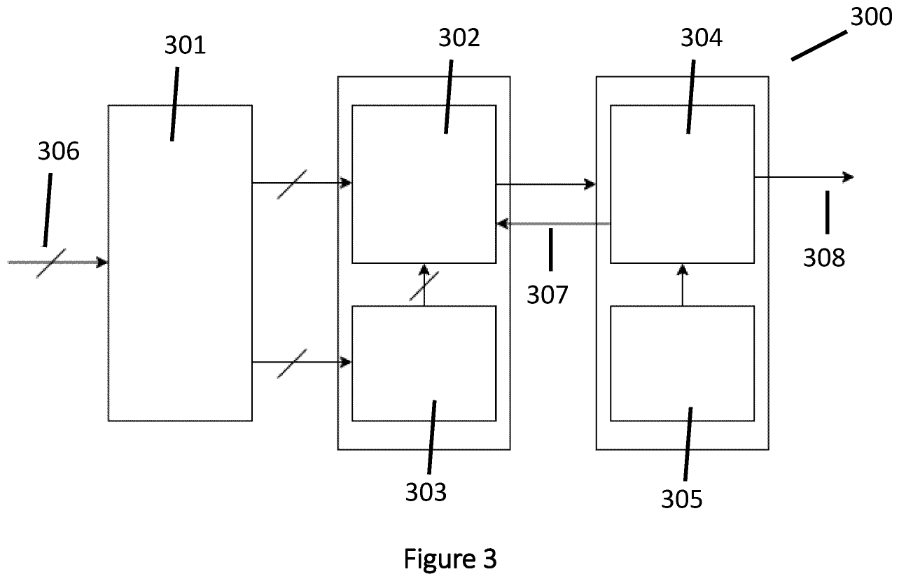

FIG. 3 shows a schematic depiction of the high-level architecture of a neuron 300 with m spike inputs, in particular using the self-timed methodology described in the previous section. The goal is to capture m input spikes 306 coming from the network and generate timing information locally in a feedforward manner to be able to do the accumulation of the weights associated for the inputs which spiked. The summation of the weights is sent to an accumulator 302, which is connected to a comparator logic 304 with threshold 305. An output spike 307 is generated when the accumulator 302 reaches the programmed threshold 305 and the accumulator resets 308.

As shown, the m input spikes 306 enter the neuron 300, and subsequently spike capture and timing generation takes place in the spike capture and timing generation module 301. Each incoming spike carries information and is typically associated with a synaptic weight. The neuron's spike capture mechanism involves detecting the arrival of incoming spikes. This detection can be based on a comparison with a certain voltage threshold. The timing generation relates to the creation of a local train of timing pulses. The capture mechanism and timing generation will be further explained below. Next, the weights 303 are applied to the different captured spikes and the spikes are accumulated in the accumulator 302. The accumulator sends the accumulated signal to the comparator logic 304, where the accumulated signal is compared with a threshold 305. The threshold 305 can be fixed or variable. When the accumulated signal reaches the threshold 305, an output spike 307 is generated which is sent to (another part of) the network or to an output layer. The accumulator may be made to reset 307, using for example a reset signal sent from the comparator 304, once the output spike 307 is generated and the neuron “fires”. This brings the accumulated signal in the accumulator 302 back to zero, or some other predetermined level.

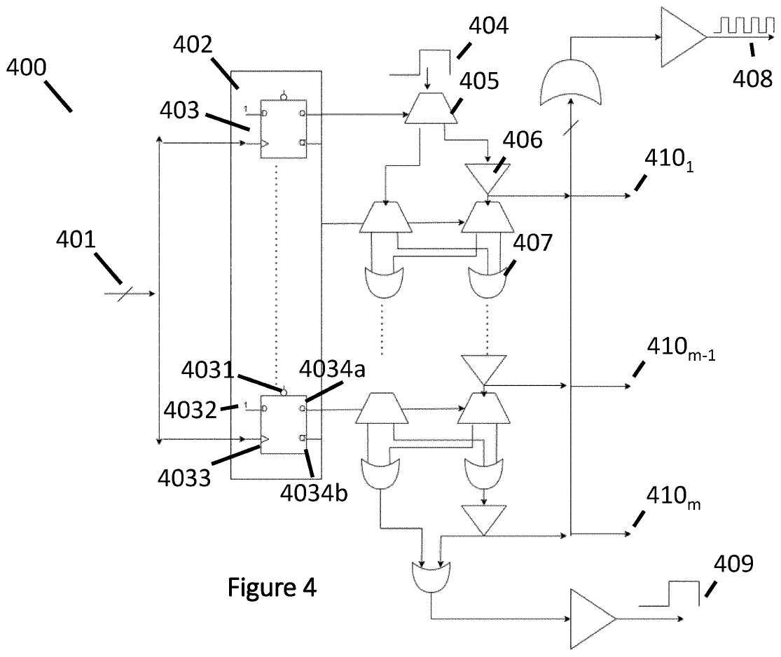

FIG. 4 shows a schematic depiction of the capture of m spike inputs 401 and the associated timing generation in a spike capture and timing generation module 400, in particular an example of the realization of the capture of spikes received from the network, more in particular an example of how the spike capture and timing generation module 301 can be implemented.

The captured spikes can be used for the generation of local and/or multi-level timing information at the neuron itself, since the system need not be based on or make use of clocks. The spikes can be captured using pulse latching in pulse capture module 402, for example using m latches. An example of such a pulse latch is a standard CMOS D Flip flops 403. However, the spike capture can be performed using any other logic method, this is just an example. In general, spike capture of pulse latching can generate a logical state out of a pulse, such that the logical state generated indicates whether a pulse happened or not. Multiple different spike capturing methods can used in the same pulse capture module 402, within the same neuron, or within the network.

A CMOS D Flip-Flop (DFF) 403 is a digital circuit element that stores a single bit of information. The “D” in CMOS D Flip-Flop stands for “Data.” The flip-flop can comprise a data input (D) 4032, a clock input (CLK or CP) 4033, a set input(S), a reset input (R) 4031, and/or complementary outputs (Q and Q-bar) 4034a,4034b. The DFF outputs the data input signal of the D input at one or both complementary outputs Q and Q-bar when triggered by the clock signal received at the CLK input.

The CMOS D flip-flop 403 can be used to capture a spike signal for a neuron by serving as part of the circuitry that processes and integrates incoming spike events. The D flip-flop acts as a spike capture element, where the D (Data) input 4032 of the flip-flop is set to be a logical 1, and the CLK input 4033 is connected to a particular spike input signal 401 (e.g., coming from a particular input synapse to the neuron).

The clock input of the flip-flop is driven by a clock signal, in this case the respective spike input signal corresponding to a respective DFF is used as the clock signal for that DFF. That means that if a particular spike signal is sent to the neuron, the corresponding DFF captures the logical 1 signal at a specific edge of the spike input signal and passes it through to the outputs Q and Q-bar.

Q and Q-bar 4034a,4034b are logical complements of each other. If Q is in a high state (logical 1), then Q-bar is in a low state (logical 0), and vice versa. The two outputs always have opposite logical values. The complementary nature of Q and Q-bar 4034a,4034b allows for the convenient generation of inverted signals without the need for additional logic gates. The S and R inputs are asynchronous inputs that can force the Q output 4034a to a high or low state, respectively, regardless of the clock and data inputs.

The output of each of the latches, for example the Q output 4034a of each CMOS D flip-flop, can be connected to the control input of a demultiplexer (DMUX) 405. A demultiplexer is a digital circuit that takes a single input and directs it to one of several possible outputs based on one or more control signals. Each DMUX can be controlled by the output of the DFF, i.e., the value of the output of the DFF determines to which output the DMUX directs its input signal. In this case, the input signal 404 of the first demultiplexer—controlled by the first latch connected to the first spike input port—can be a signal comprising a single pulse.

If via the i-th input a spike was captured (with i∈{1, . . . , m}), then the output of the i-th DMUX can be sent through a delay element 406 and then onwards to the (i+1)-th demultiplexer controlled by the latch connected to the (i+1)-th input. If via the i-th input no spike was captured (with i∈{1, . . . , m}), then the output of the i-th DMUX can be sent onwards to the (i+1)-th demultiplexer controlled by the latch connected to the (i+1)-th input, without passing through a delay element 406.

For i∈{1, . . . , m}, if a spike was captured, the signal 410ᵢ coming from the corresponding i-th delay element is also forwarded to a shared OR gate element 407, which combines the signals coming from all delay elements for which a spike was captured into a train of timing pulses, the local timing signal 408. Preferably, this shared OR gate element is a pulseor-tree element, which combines signals comprising pulses carried over different input lines into a single output line that pulses whenever one of the different input lines pulses. The local timing signal 408 can be used by the neuron to synchronize and/or control the timing of operations in the neuron, serving as a local trigger signal. The local timing signal 408 comprises a number of pulses equal in number to the number of spikes captured by the pulse latch module 402. The spacing between the pulses, created by the delay elements 406, can be based on the minimum time taken by the accumulation for a particular weight associated with a particular input spike line, as will be explained further below.

A delay element 406 can be present to delay the local timing signal 408, such that the local timing signal 408 arrives at a definite time at a next part of the neuron.

In other words, in this embodiment spike capture and local trigger generation module 400 for a neuron of a spiking neural network is disclosed. The module may comprise multiple spike input ports 401. Each of the multiple spike input ports may be configured to receive a spike input signal from the spiking neural network. Furthermore, a pulse latch module 402 may be comprised within the module. The pulse latch module may be configured to capture spikes in the spike input signals received by the spike input ports by pulse latching. Pulse latching can be described as a digital circuit mechanism that captures and retains a state in response to a triggering pulse, storing the state until reset by a subsequent pulse. The state can be forwarded to other parts of the module. The pulse latch module may output for each of the multiple spike input ports a latched signal which indicates whether or not a spike was captured. Furthermore, a local trigger generator module may be comprised within the module. The local trigger generator module may be configured to generate a trigger signal used by the neuron to synchronize and/or control the timing of operations in the neuron. The local trigger generator module may be configured to use the multiple latched signals to generate the trigger signal such that the trigger signal comprises one or more pulses equal in number to the number of spikes captured by the pulse latch module. The trigger signal thus obtained may be used to trigger operations performed by other parts of the neuron, hence providing a local event-based triggering mechanism. The invention thus does not need a global clock signal to operate those parts of the neuron. In order to use the trigger signal, the module may comprise a trigger signal output port 408, configured to output the generated trigger signal.

Each of the signals 410i coming from a delay element can also be outputted by the spike capture and timing generation module 400 to a different part of the neuron. For example, the output signals 410ᵢ, representing that the corresponding spike input 401 comprised a spike can be outputted by the spike capture and timing generation module 400. In the present embodiment, since these output signals 410ᵢ are delayed by the delay elements 406, these output signals 410i each will have a different delay and thus are outputted by the spike capture and timing generation module 400 one after the other.

Another option is that the spike capture and timing generation module 400 forwards the input signals 401 directly as the output signals 410ᵢ. It is also possible that each latch element 4033 controls a pulse generator which outputs a pulse in a particular output 410i if the latch element 4033 has determined that a spike was present in the input signal. Each output 410ᵢ can then have their own separate pulse generator, or a pulse generator can be shared between multiple outputs 410ᵢ.

The local timing signal can also be determined in other ways. For example, the different latch elements 4033 might detect whether a spike occurs in a particular input channel, and the number of latch elements which detect a spike may be determined, for example via a counter element. A pulse generator may then be controlled to output a local timing signal 408 with a number of pulses equal to the number of detected input spikes to the spike capture and timing generation module 400.

The signal inputs 401 can also be grouped into different sets of various number of signal inputs 401. A local timing signal 408 can then be generated per set of signal inputs 401, for example in one of the exemplary manners described above.

The spike capture and timing generation module 400 might also not output the spike output signals, but instead only generate the local timing signal 408.

If i=m then the output of the m-th DMUX (or of the corresponding delay element) can be sent via OR gate element 407 to be output as a multi-level timing signal 409, which will be described in more detail below. The multi-level timing signal 409 is generated to demarcate the timing generation end of a particular level of summation. The delay of the multi-level timing has to be greater than the delay of all the summations done in a particular level. The levels are explained further below. More than one multi-level timing signal may need to be generated depending on how the process of accumulation is performed in the neuron.

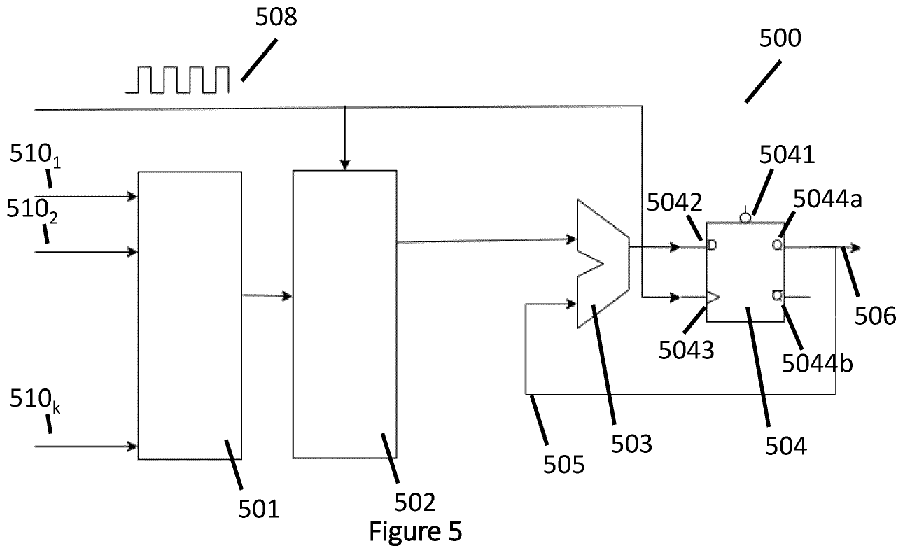

FIG. 5 shows a schematic depiction of the summation of spike weights from a local memory in a unit cell 500, in particular the figure shows k spike inputs 510₁-510ₖ out of a total m spike inputs of the neuron (k can be smaller or equal to m). A unit cell 500 in this case is thus part of a neuron responsible for the accumulation, and in this example has k out of m spike inputs. The spike inputs 510₁-510ₖ in this case are connected to the respective spike outputs 410ᵢ shown in FIG. 4 coming from the spike capture and timing generation module 301. Thus, by virtue of using these unit cells, m inputs to the accumulator are split into one or more sets of k. The reason for splitting m inputs into sets of k is the trade-off between the following.

Namely, the greater the gate count of a combinational logic operation like accumulation, the greater the uncertainty on maximum time taken to complete it. The design methodology can be based on maximizing time, so the greater the uncertainty, the slower the overall design becomes, since delays in the design need to be kept for maximum possible time based on the timing uncertainty. Furthermore, the greater the delay, the more uncertain the delay becomes. So, this uncertainty adds on top of the uncertainty of the combinational logic delay. The goal is to split the design into logic blocks which can then be used as reproducible design blocks (as was shown in FIG. 1). These reproducible blocks need to be timed within the same layer and between the layers as shown further below.

For the summation of spikes coming in as shown in FIG. 5, it is expected that inputs which had spikes are high (whether or not a spike occurred can be determined using the logic in FIG. 4, by virtue of the latching module) and the correct number of pulses have been generated to time the accumulation operation of all the weights associated with the inputs that had spikes.

The inputs 510₁-510ₖ go to an encoder 501, which encodes a spike from an input to a memory address. The encoder can also reorder the summation sequence if necessary, for example based on certain rules of priority. The encoder 501 can also do operations like delay the summation for one delay cycle so that the summation can take place with the next set of inputs that come in. The encoder 501 may pass a memory address for each pulse input 510₁-510ₖ received to the local memory 502, for example an SRAM or non-volatile memory like ReRAM.

The weight stored in the memory corresponding to the address for each pulse in inputs 510₁-510ₖ received is passed onto the accumulation element 503. An accumulator performs the function of addition/subtraction of the incoming input on the last saved value. Combination of 503 and 504 achieves this. In this case 503 could be an adder, subtractor or both in standard CMOS logic. Thereafter, the signal from accumulation element 503 is for example passed on to the D input 5042 of a CMOS D flip-flop 504. The local timing signal 508 may also be passed as input to the CMOS D flip-flop 504, namely at the CLK input 5043. DFF 504 captures the incoming accumulated weight signal at a specific edge of the clock signal corresponding to a pulse in the local timing signal 508.

The DFF has a feedback-loop from its output, for example from the Q port 5044a, back to the accumulation element 503. In this way, the accumulated weight is outputted by the DFF and used as a second input to the accumulation element 503. The accumulation element in the meantime has obtained a next weight from the local memory 502 and sums the new weight with the already accumulated weight into a new accumulated weight. This new accumulated weight is then sent to the DFF 504 again. Since the local timing signal 508 comprises a number of pulses equal to the number of times a signal is received from the accumulation element 503, the accumulation of the weights of all the signal inputs 510₁-510ₖ for which a spike was received is in this manner performed.

In other words, the local timing signal 508 comprises a number of pulses corresponding to an incoming spike signal. Each pulse is used to determine when a particular (accumulated) weight coming from the local memory 502 is captured. The captured weights are integrated over time through successive clock cycles. The DFF 504 accumulates the presence of spikes over multiple clock cycles (e.g., after each trigger from the local timing signal 508), providing a form of temporal integration. In this way, the operation with respect to logic encoded in the accumulator corresponding to the weight can thus be performed. As mentioned, this process can be repeated for all input spikes 510₁-510ₖ which are captured. Multiple unit cells may perform this function within the neuron, thus making sure the accumulation of all m spike signals 410₁-410ₘ takes place. The local timing pulse 408, 508 is expected to be delayed enough from the start of the pulse for spikes to be processed in the accumulator, e.g. in the DFF 504. The start of the pulse was used to convey that local timing pulse 408 had an additional delay in it. This additional delay can be used to control the relative timing of when the logic reaches for example the local memory 502, or the accumulation element 503 relative to the timing of local timing pulse 508.

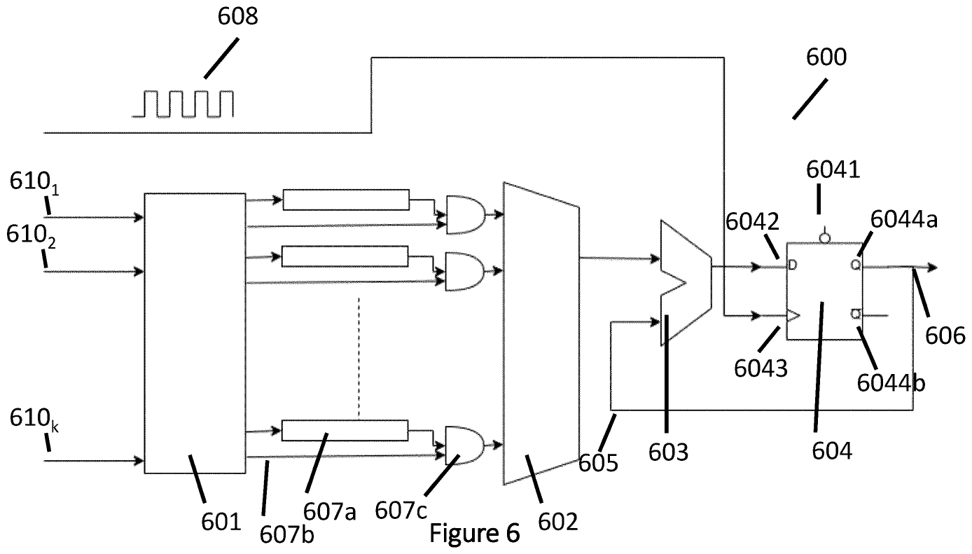

FIG. 6 shows a schematic depiction of the summation of spike weights from a distributed memory in a unit cell. In particular, FIG. 6 shows an alternative implementation of the accumulation of weights to the one shown in FIG. 5.

The inputs 610₁-610ₖ go to a priority encoder 601, but in this case may pass an address for each pulse input 610₁-610ₖ received to one of the distributed memory elements 607a having a size of j bits and having stored therein a weight corresponding to a particular input 610₁-610ₖ. If no input spike is received at a certain input, then this corresponds to a logical 0 signal through the corresponding channel 607b. If an input spike is received at a certain input, then this corresponds to a logical 1 signal through the corresponding channel 607b. Next, the weight from 607a and the signal from channel 607b is passed through AND gate element 607c. If the channel 607b carries a logical 1, then the weight of the input is forwarded to the multiplexer 602. All outputs from AND gate elements 607c corresponding to all the inputs 610₁-610ₖ are then passed through a multiplexer 602. The multiplexer 602 can go through the channels one by one and forward the weights to the accumulator logic.

The weight stored in the distributed memory corresponding to the address for each pulse input 610₁-610ₖ received is thus passed onto the accumulator. In an example, the weight stored is passed onto a accumulation element 603. Thereafter, the signal from accumulation element 603 is for example passed on to the D input 6042 of a CMOS D flip-flop 604. The local timing signal 608 may also be passed as input to the accumulator, for example to the CMOS D flip-flop 604, namely at the CLK input 6043. DFF 604 captures the incoming weight signal at a specific edge of the clock signal corresponding to a pulse in the local timing signal 608.

The DFF has a feedback-loop from its output, for example from the Q port 6044a, back to the accumulation element 603. In this way, the accumulated weight is outputted by the DFF and used as a second input to the accumulation element 603. The accumulation element in the meantime has obtained a next weight from the distributed memory, for example from the multiplexer 602, and sums the new weight with the already accumulated weight into a new accumulated weight. This new accumulated weight is then sent to the DFF 604 again. Since the local timing signal 608 comprises a number of pulses equal to the number of times a signal is received from the accumulation element 603, the accumulation of the weights of all the signal inputs 610₁-610k for which a spike was received is in this manner performed.

In other words, the local timing signal 608 comprises a number of pulses corresponding to an incoming spike signal. Each pulse is used to determine when a particular (accumulated) weight coming from the distributed memory 602 is captured by the DFF. The captured weights are integrated over time through successive clock cycles, trigger by the local timing signal 608. The DFF 604 accumulates the presence of spikes over multiple clock cycles (e.g., after each trigger from the local timing signal 608), providing a form of temporal integration. In this way, the operation with respect to logic encoded in the accumulator corresponding to the weight can thus be performed. As mentioned, this process can be repeated for all input spikes 610₁-610ₖ which are captured. Multiple unit cells may perform this function within the neuron, thus making sure the accumulation of all m spike signals 410₁-410ₘ takes place. The local timing pulse 408, 608 is expected to be delayed enough from the start of the pulse for spikes to be processed in the accumulator, e.g. in the DFF 604.

In this way, the weights associated with the input spikes 610₁-610ₖ can be instantiated using distributed weight storage elements, for example comprising latches and/or flip flops. The benefit of the distributed weight storage mechanism is that traditional place and route tools (for example Innovus, ICCII, Openroad; all readily available software solutions) can optimize the combinational logic around the weights and the generation of modules using the design methodology shown in FIG. 2, for all the different logic blocks which are needed in this methodology, can be automated with minimal human intervention. Additionally, the logic storage elements like latches or flip flops present the designers with the option of undervolting the supply to them, this leads to a comparable leakage values to memories like SRAM and ReRAM, while potentially improving the dynamic power by a lot. Undervolting involves intentionally reducing the operating voltage (VDD) below the standard or nominal level specified for the latch or flip-flop. This can be done for various reasons, including power optimization and energy efficiency.

A weight encoding and accumulation module for the accumulation of spike input signals in a neuron of a spiking neural network is thus disclosed in FIGS. 5 and 6. The module may comprise multiple spike input ports 510,610. Each of the multiple spike input ports may be configured to receive a spike input signal. Furthermore, the module may comprise a trigger signal input port 508,608, which may be configured to receive a trigger signal. The pulses comprised in the trigger signal may indicate the number of spikes received by the multiple spike input ports. Furthermore, the module may comprise a spike-to-weight encoder module. The spike-to-weight encoder module may be configured to receive the spike input signals and output a corresponding weight associated with a particular spike input signal. This may be done by encoding the received spike input signals as weight. Furthermore, an accumulator module may be comprised in the module. The accumulator module may be configured to receive the weight from the memory module and the trigger signal and accumulate the weights of received spikes. The timing of one or more of the operations involved in the accumulation may be governed by the trigger signal. In this case the loop circuit, formed by the CMOS D Flip Flop, is governed by the trigger signal. An other way of triggering the accumulation using the trigger signal may also be envisioned.

By the method of delay-based serialization, shown in FIGS. 4-6, only the spikes which are captured are serialized and added in the adder. Using the combination of delay-based timing (for worst case setup time of adder) and the feed-forward nature of the design only particular constraints (for example, delay of each logic block in the design and the delay of the delay cell) need to be met for the correct functionality of the design. Note that if the design is feedforward and the logic paths are well balanced, then from a timing perspective, one can only target to solve a setup time problem and not a hold time problem. Hold time is also alleviated if a particular timing signal leads to capturing of a data into a latch is pulse rather than an edge (so pulse-based latching rather than edge-based latching). So, if we are only solving a setup time issue, it is understood that one can always fix the setup time issue by slowing down the design. Using variable distributed delays, one can solve setup time issues in every part of the design.

Additionally, the spacing between the pulses must be greater than the time needed to access a particular memory plus the accumulation time. As mentioned before, the pulse reaching the accumulator can be delayed further compared to the ones going to the memory (as done in local timing signal output 408). Since SNN are spare networks with periods of high activity, the above design approach is able to process high activity periods but is at the same time capable to not have unnecessary dynamic power consumption in the low activity periods.

Note that the unit cells 500,600 shown in FIGS. 5 and 6 for example take as input analog signals, and output a digital value being the accumulated sum of the weights of the input signals that comprised a spike. One call also design a second kind of unit cells which simply add digital values of weights together. These can be used in further layers of the addition scheme of the neuron, where through parallelization multiple unit cells took as input analog signals and converted these into digital signals, and the second kind of unit cells can be used to add the digital signals (representing accumulated weights) into an accumulated weight.

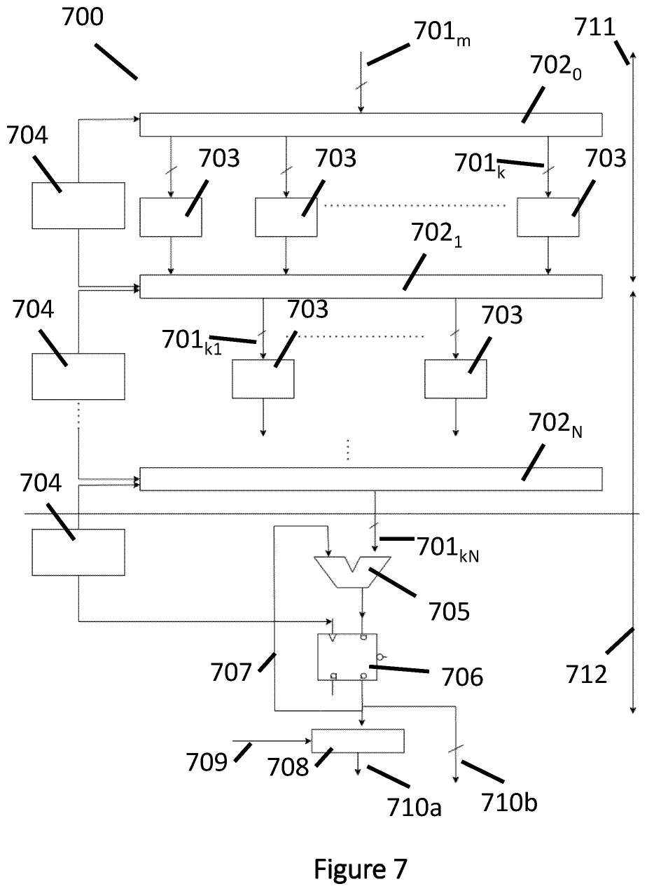

FIG. 7 shows a schematic depiction of a multi-level self-timed neuron design with reproducible unit cells. In particular, the high-level architecture of how multiple inputs are split in a given summation level and across different levels are shown. Due to the trade-offs between logic complexity and timing uncertainty, m inputs in a neuron are split into smaller sets of inputs, for example all into k inputs, being the same or a different number of inputs across sets. For each set, each of the k inputs are processed in a unit cell. A unit cell may comprise an architecture described in FIG. 5 or 6.

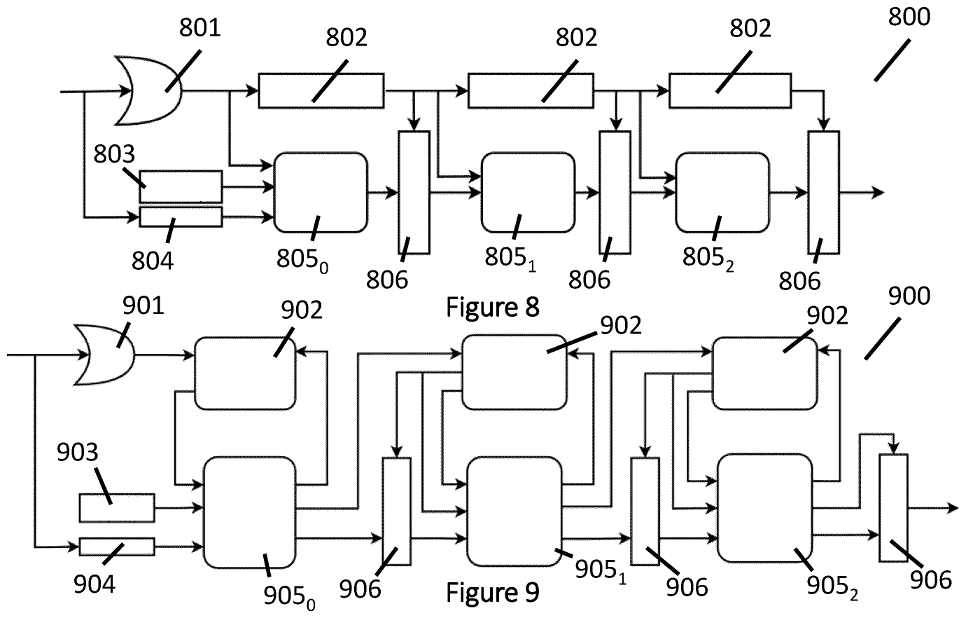

Each of the unit cell may generate a timing signal of when it finishes its computation as shown in FIG. 4 with the multilevel spike timing signal. As an example a finish signal can be generated by an additional delay signal running in parallel to the logic. As long as the delay signal is longer than the worst-case delay of the logic, the multi-level timing signal will be always indicate a timing (through e.g., a pulse) after the worst-case delay of the logic. Finish signal of multiple unit cells in a level can be the OR of individual finish signals. This can be applied in multiple-stage pipeline design implemented in a feedforward manner through a delay-based timing approach. See for an example FIG. 8 below.

The accumulation can be performed in different levels. When accumulation is split into different levels, it means that the integration process occurs independently or hierarchically at each level of the system. In neural networks or signal processing systems, information is often processed at different levels of abstraction. Each level may represent features or patterns at varying degrees of complexity.

There are multiple reasons to split the addition in different levels. First of all, pipelining improves the throughput at the cost of latency. Furthermore, in delay-based timing there is an additional trade-off that the timing uncertainty increases when one tries to improve the latency by increasing the logic in a single level. This increase in timing uncertainty deteriorates the latency.

The multi-level spike timing signal 409, for example as generated using the spike capture and timing generation as shown in FIG. 4, can be used to do timing between different levels using the feedforward timing as shown in FIG. 8 and/or using handshaking as shown in FIG. 9.

At the input 701ₘ, m different inputs to the neuron 700 enter the neuron 700. These can correspond for example to the input synapses to the neuron 700. The different input spikes are latched at latch 702₀. This can be done using for example the spike capture and timing generation module 301, 400 as shown in FIG. 4.

Next, the input signals can be split into smaller sets of k inputs 701ₖ and serve as input to respective unit cells which accumulate the input signals 701ₖ. The unit cells can be as shown in FIG. 5 or 6 discussed above. At the end of the level 0, the accumulated signals coming from the unit cells 703 are latched into a level 1 register set 7021. The region 711 indicates that the unit cells 703 in this region 711 are spike-driven unit cells, for example the unit cells shown in FIGS. 5 and 6, which take as input an analog signal comprising spikes. From this point onward in the neuron logic, the accumulation unit cells 703 can be made both spike-driven or data-driven. As an example, the region 712 indicates that the unit cells in this region 712 are data-driven unit cells, for example the unit cells which take as input digital signals as described above and accumulate the values of these digital signals.

Since the implementation generates a multi-level timing signal which indicates when level 0 completes its computation (as was shown in relation to FIG. 4), this can be used as an input change signal and the rest of the unit cells don't need to be timed internally, they can be made from conventional CMOS and timed using static timing analysis (STA). Note that standard CMOS logic can be made to operate without a clock. The design can for example be done using maximum and minimum delay constraints. Standard software EDA synthesis tools like Design Compiler and Genus can determine these constraints. They ensure that logic created always has a delay greater than minimum delay and less than the maximum delay. Since the timing between the levels is still delay driven and the timing uncertainty with longer delays still holds true, further splitting of levels might be needed based on the timing trade-offs described before.

Better trade-offs can be achieved in latency of a particular level vs the timing uncertainty, by doing time-multiplexing within a given level. If we know that a previous level takes more time than the current level (due to logic trade-offs within the previous level), the current level can be optimized to process more information by doing time-multiplexing. The timing in that case will still be done via delay-based signals and standard time-multiplexing approaches can be used.

For the first level, the latched accumulated signals which were latched into the level 1 register set 702₁ are split into sets of k1 input signals 701ₖ₁, which are then each respectively forwarded to accumulation unit cells 703 which may operate by taking accumulating the digital accumulated signal values.

At the last level, the output from the second to last layer of unit cells is latched by the level N register set 702N. The spike input 701kN is then send through ... element 705, into an accumulator 706, for example the DFF 706, in particular the spike input 701kN is sent to the D port of the DFF 706. As such, at the end of the last level, accumulation is done on the previous summation. The timing is still delay-based feedforward or delay-based handshaking.

When the last level accumulator 706 reaches a preset threshold 709, an output spike 710a is generated for example by the comparator 708 that checks whether or not the accumulated signal has reached the preset threshold 709, and the accumulated value in the accumulator 706 is reset to a predetermined value. The accumulator 706 can send the accumulated signal to the comparator 708, where the accumulated signal is compared with a threshold 709. Furthermore, the accumulator 706 can output the accumulated sum 710b as a separate output. This can be used as a real time signal used in training and inference in neural networks.

Pipelining of multiple small accumulators like the k input unit cell accumulators 703 needs to be done in order to be able to create a high fan-in accumulator of m inputs. Such a pipeline as shown in FIG. 7 can be implemented through various approaches. The logic of which is present in control logic 704.

FIGS. 8 and 9 show two potential methods for the implementation of the pipeline of FIG. 7.

FIG. 8 implements the multiple-stage pipeline design in a feedforward manner using a delay-based timing approach.

The input signals enter a pulse latch 804, and a pulseor-tree element 801, which combines signals comprising pulses carried over different input lines into a single output line that pulses whenever one of the different input lines pulses. The output from the pulse latch 804, the weights saved in the weight memory 803 and/or the output of the pulseor-tree element 801 can be used as input to the L0 logic 805₀. Next, the output of the L0 logic 805₀ is sent to a register 806. The output from the pulseor-tree element 801 is sent through a delay, which generates a delay signal equal to or greater than the processing time of the L0 logic 805₀. This delay signal is used as an input to the register 806 to determine when the register should forward its latched signal to the next level logic, in this case L1 logic 805₁. The delay signal is also used as input to the level logic L1 logic 805₁. The delay signal is also send to a different delay element 802 corresponding to the level logic L1 logic 805₁ such that the delay it generates is equal to or greater than the processing time of the level logic L1 logic 805₁. This methodology is repeated for the remaining layers.

FIG. 9 implements the pipeline structure using an interstage handshaking mechanism. For handshaking correct loop breaking needs to be implemented for the proposed constraints and methodology to work.

The input signals enter a pulse latch 904, and a pulseor-tree element 901. The output from the pulse latch 904, the weights saved in the weight memory 903 can be used as input to the L0 logic 905₀. Next, the output of the L0 logic 905₀ is sent to a register 906. The output from the pulseor-tree element 901 is also sent to a control logic 902, which initiates a handshake procedure with the L0 logic 905₀ by sending a synchronize (SYN) signal, to which the L0 logic 905₀ will respond when ready with an acknowledgement (ACK) signal.

When the L0 logic 905₀ is ready, it outputs an output signal to the register 906, which latches the output signal. Furthermore, it sends a signal to a next control logic 902, which performs a handshake procedure with the next logic layer L1 logic 905₁. Furthermore, this control logic 902, on the basis of the signal received from the first L0 logic 905₀ sends a signal to the register 806 to output the latched data as input signal to the logic layer L1 logic 905₁. This methodology is repeated for the remaining layers.

Correct optimization can help in optimizing the throughput of the pipeline further since depending on the use case traffic each stage of the pipeline can be multiplexed. This gives an added flexibility since network traffic can be either high throughput or low latency or a combination of the two. Correct design topology can be determined by flexible pipeline depth and delay-based time multiplexing mixture.

The designs described in this work are more at high architecture and logic functionality level. Depending on the power, area and performance requirements, the actual implementation can be done in fast design methodologies like Self resetting CMOS, pulse-based designs or if the requirements are not stringent than in standard CMOS using modified Static timing analysis for delay based timing closure as described in the methodology section.

The neurons designed using the above examples can be further optimized for a particular use case.

If the use case does not utilize all the possible input lines, we know that delay in particular stages can be decreased significantly. This will lead to a trade-off improvement in both latency and throughput but controlling the delays in each stage. This is different from the conventional clock-based design techniques, where the granularity of control is more global due to the clock network designs becoming more complex at local level. Typically, latency and throughput are inverse of one another and are fixed by design. Using this methodology, they can both be improved and also made use case dependent.

Since the delays can be made using mixed signal design techniques, we can also alleviate any process, temperature and voltage issues using similar calibration techniques.

AND gates in the present description can be implemented using semiconductor devices such as transistors to perform logical conjunctions, while OR gates use similar components for logical disjunctions. Pulse latches can be constructed using flip-flops and pulse generators. Accumulators may employ operational amplifiers and/or digital counters. Subtractor circuits can be comprised of arithmetic units capable of computing differences. Input and output ports are designed with interface modules, allowing seamless communication between neurons.

The present invention discloses among others the implementation of spiking neurons and spiking neural networks in hardware, for example on a chip. Silicon is the predominant material used in semiconductor fabrication. Metal-Oxide-Semiconductor Field-Effect Transistors (MOSFETs) are the fundamental building blocks of digital integrated circuits. They may be used to implement logic gates, memory cells, and other essential components. SRAM is commonly used for fast and volatile storage of synaptic weights, neuron states, and other dynamic information within the SNN. For more permanent storage needs, non-volatile memory technologies like Flash or Resistive Random-Access Memory (RRAM) can be employed. Multiple metal layers can be used for interconnecting different components on the chip. These layers facilitate the routing of signals between neurons, synapses, and other functional units. Through-Silicon Vias (TSVs) may be used to enable vertical stacking of multiple layers, improving the overall connectivity and reducing the physical footprint.

Energy-Efficient Design Techniques like voltage scaling (adjusting the operating voltage dynamically to balance power consumption and performance), clock gating (temporarily halting the clock signal to idle portions of the circuit during inactive periods) and/or power gating (completely shutting off power to specific sections of the chip when not in use) may be used. By virtue of the present application a local timing is generated based on certain trigger events (in this case receiving a spike), which can help in obtaining an energy-efficient design.

Note that features of any of the embodiments disclosed herein may be combined in an appropriate manner.

1. A spike capture and local trigger generation module for a neuron of a spiking neural network, comprising:
a plurality of spike input ports, wherein each spike input port is configured to receive a spike input signal from the spiking neural network;
a pulse latch module , configured to capture spikes in one or more of the spike input signals, wherein the pulse latch module outputs a signal which indicates if a spike was captured at one of the spike input ports;
a local trigger generator module, configured to generate a trigger signal for use by the neuron to synchronize and/or control the timing of operations in the neuron, wherein the local trigger generator module is configured to generate the trigger signal based on the signal from the pulse latch module, wherein the trigger signal comprises a number of pulses equal to a number of spikes captured by the pulse latch module; a trigger signal output port, configured to output the generated trigger signal.

2. (canceled)

3. The spike capture and local trigger generation module of claim 1, wherein the trigger signal indicates a number of spikes captured by the pulse latch module during a predetermined time period.

4-5. (canceled)

6. The spike capture and local trigger generation module of claim 1, wherein the one or more pulses comprised in the trigger signal have a certain spacing between the pulses, which is determined by the minimum time taken to perform the operations in the neuron.

7. The spike capture and local trigger generation module of claim 1, further comprising multiple spike output ports, each configured to output a spike output signal, wherein each of the multiple spike output ports corresponds to one of the multiple spike input ports, and wherein a particular spike output port is configured to output a pulse if a corresponding spike input port received a spike.

8. The spike capture and local trigger generation module of claim 7, wherein the pulses outputted by the spike output ports are spaced in time substantially the same as the pulses comprised in the clock signal.

9. The spike capture and local trigger generation module of claim 1, wherein pulse latch module comprises multiple latch elements, each latch elements configured to capture one or more spikes in the spike input signal received by a particular spike input port by pulse latching.

10. The spike capture and local trigger generation module of claim 9, wherein the latch element is a CMOS D Flip-Flop, wherein the CMOS D Flip Flop is triggered by a spike input signal and wherein the latched signal outputted by the CMOS D Flip Flop is a bit value indicating whether a spike was latched or not.

11. The spike capture and local trigger generation module of claim 1, wherein the local trigger generator module comprises a pulse generator which generates a pulse,
wherein the local trigger generator module comprises delay logic for each spike input port, and wherein the generated pulse is sent through each of the delay logic subsequently.

12. The spike capture and local trigger generation module of claim 11,
wherein each of the delay logic comprises a delay element that delays the pulse signal,
wherein the generated pulse is sent through the delay element of a particular delay logic if the corresponding latched signal indicates that a spike was captured by the corresponding spike input port, and wherein the generated pulse is not sent through the delay element of the particular delay logic if the corresponding latched signal indicates that a spike was not captured by the corresponding spike input port.

13. (canceled)

14. The spike capture and local trigger generation module of claim 1, wherein the local trigger generator module is configured to generate multiple trigger signals used by the neuron to synchronize and/or control the timing of operations in respective parts of the neuron, wherein the local trigger generator module is configured to use the multiple latched signals to generate the multiple trigger signals such that each trigger signal comprises one or more pulses equal in number to the number of spikes captured by the pulse latch module for a particular set of spike input ports; and
further comprising multiple trigger signal output ports, configured to output the generated trigger signals.

15. The spike capture and local trigger generation module of claim 1, further comprising a multi-level trigger generator module having a multi-level trigger output port which is configured to generate a multi-level trigger signal, wherein the multi-level trigger signal indicates the total time it would take the neuron to perform the operations triggered by trigger signal.

16. A spiking neuron for a spiking neural network comprising:
a spike capture and local trigger generation module according to claim 1; and
a weight encoding and accumulation module, wherein the weight encoding and accumulation module comprises:
a plurality of spike input ports, wherein each spike input port is configured to receive a spike input signal;
a trigger signal input port, configured to receive, from the spike capture and local trigger generation module, a trigger signal comprising a number of pulses equal to a number of spikes received by the spike input ports;
a spike-to-weight encoder module, configured to receive the spike input signals and output a corresponding weight associated with a spike input signal when a spike is received in the spike input signal;
an accumulator module, configured to receive the trigger signal and the weights from the spike-to-weight encoder module, and accumulate the weights, wherein the timing of one or more of the operations involved in the accumulation is based on the trigger signal.

17-18. (canceled)

19. The spiking neuron of claim 16, wherein the accumulator module comprises an accumulation element and a loop circuit which takes as input the output of the accumulation element and which outputs a value back to the accumulation element each time the loop circuit receives a pulse from the trigger signal, wherein when the spike-to-weight encoder module outputs a first weight to the accumulation element, the first weight is summed by the accumulation element with a second weight outputted by the loop circuit.

20. (canceled)

21. The spiking neuron of claim 16, wherein the spike-to-weight encoder module comprises a local memory, and wherein the spike-to-weight encoder encodes a pulse received at a particular spike input port as a memory address which is used to request a weight stored in that particular memory address, the weight associated with the particular spike input port.

22. The spiking neuron of claim 16, wherein the spike-to-weight encoder module comprises a distributed memory comprising distributed weight storage elements, and wherein the weights associated with the spike input ports are each stored in one of the distributed weight storage elements and wherein if a spike is present in a spike input signal the corresponding weight is outputted to the accumulator module by the distributed weight storage element where the weight is stored.

23. The spiking neuron of claim 16, wherein the spike-to-weight encoder module is configured to change the order at which weights are output based on priority rules.

24. (canceled)

25. The spiking neuron of claim 16, further comprising a comparator module which compares the total accumulated weight with a predetermined threshold value, wherein the total accumulated weight is the sum of all weights of spike input ports for which a spike of the corresponding spike input signal was captured, and wherein the spiking neuron is configured to output a spike to the spiking neural network when the total accumulated weight exceeds the predetermined threshold value.

26. The spiking neuron of claim 16, wherein the spiking neuron comprises multiple weight encoding and accumulation modules and wherein the spike capture and local trigger generation module is configured to generate multiple trigger signals used by the neuron to synchronize and/or control the timing of operations in respective parts of the neuron, wherein the local trigger generation module is configured to use the multiple latched signals to generate the multiple trigger signals such that each trigger signal comprises one or more pulses equal in number to the number of spikes captured by the pulse latch module for a particular set of spike input ports; and wherein the local trigger generation module further comprises multiple trigger signal output ports, configured to output the generated trigger signals and wherein each of the multiple trigger signal output ports outputs a respective trigger signal to the trigger signal input port of a corresponding weight encoding and accumulation module, such that the timing of one or more of the operations involved in the accumulation performed in the corresponding weight encoding and accumulation module is governed by the respective trigger signal.

27-28. (canceled)

29. The spiking neuron of claim 26, wherein delay-based pipelining and/or handshake-based pipelining is used to synchronize the accumulation operations among the multiple weight encoding and accumulation modules.

30. The spiking neuron of claim 29, wherein the spike capture and local trigger generation module is further comprises a multi-level trigger generator module having a multi-level trigger output port which is configured to generate a multi-level trigger signal, wherein the multi-level trigger signal indicates the total time it would take the neuron to perform the operations triggered by trigger signal, and wherein the multi-level trigger signal is used to synchronize the accumulation operations between the multiple weight encoding and accumulation modules.

31. A method for spike capture and local trigger generation in a neuron of a spiking neural network, comprising:
receiving a plurality of spike input signals from the spiking neural network;
capturing spikes in the spike input signals by pulse latching;
generating a latch signal for each of the spike input signals, wherein the latch signal indicates if a spike was captured;
generating a trigger signal based on the latch signals, wherein the trigger signal indicates a number of spikes captured, wherein the trigger signal is used by the neuron to synchronize and/or control the timing of operations in the neuron; and
outputting the generated trigger signal.

32. The method of claim 31, further comprising outputting a spike output signal, wherein the trigger signal is generated such that the operations in the neuron can be triggered by the trigger signal and not by a global clock signal of the spiking neural network.

33. A method for weight encoding and accumulation in a neuron of a spiking neural network, comprising:
receiving a plurality of spike input signals;
receiving a trigger signal indicating a number of spikes received in the spike input signals;
obtaining or generating a weight associated with one of the spike input signals when a spike is received in the spike input signal;
accumulating the weights associated with the spike input signals, wherein the timing of one or more of the operations involved in the accumulation is based on the trigger signal; and
outputting the accumulated weight.

34. The method of claim 33, wherein the weight is obtained or generated by encoding a pulse received in the one of the multiple spike input signals as a memory address which is used to request a weight stored in a local memory at that particular memory address.

35. The method of claim 33, wherein if a spike is present in a spike input signal the corresponding weight is obtained from a distributed memory comprising multiple weight storage elements, wherein the weights associated with the spike input signals are each stored in one of the distributed weight storage elements, and wherein if a spike is present in a spike input signal the corresponding weight is outputted by the distributed weight storage element where the weight is stored and used in the accumulation of the weights.

36. A method for spike capture and accumulation in a neuron of a spiking neural network comprising:
receiving a plurality spike input signals from the spiking neural network;
capturing spikes in the spike input signals by pulse latching;
outputting a latch signal for each of the spike input signals, wherein the latch signal indicates if a spike was captured;
generating a trigger signal based on the latch signals, wherein the trigger signal indicates a number of spikes captured, wherein the trigger signal is used by the neuron to synchronize and/or control the timing of operations in the neuron;
obtaining or generating a weight associated with one of the multiple spike input signals when a spike is received in the spike input signal;
accumulating the weights associated with the spike input signals, wherein the timing of one or more of the operations involved in the accumulation is based on the trigger signal; and
outputting the accumulated weight.

37. The method of claim 36, further comprising comparing the total accumulated weight with a predetermined threshold value, wherein the total accumulated weight is the sum of all weights of spike input signals for which a spike was captured, and outputting a spike to the spiking neural network when the total accumulated weight exceeds the predetermined threshold value.

38. The method of claim 36, wherein the steps of obtaining or generating a weight and accumulating the weights is parallelized by dividing the multiple spike input signals into one or more subsets of the multiple spike input signals, and performing the steps of obtaining or generating a weight and accumulating the weights for these subsets concurrently such that one obtains an accumulated subset weight for each subset.

39. The method of claim 38, wherein the accumulated subset weights are accumulated digitally.

40. The method of claim 38, wherein delay-based pipelining and/or handshake-based pipelining is used to synchronize the accumulation operations between different subsets and/or the one or more digital accumulations.
